(19) United States
(12) Patent Application Publication
(10) Pub. No.: US 2024/0248042 A1
(43) Pub. Date: Jul. 25, 2024

(54) CRYOGENIC THERMALLY STIMULATED EMISSION SPECTROMETER

(71) Applicant: Bowling Green State University, Bowling Green, OH (US)

(72) Inventors: Farida Selim, Bowling Green, OH (US); Md Minhazul Islam, Bowling Green, OH (US)

(73) Assignee: Bowling Green State University, Bowling Green, OH (US)

(21) Appl. No.: 18/562,531

(22) PCT Filed: May 23, 2022
(86) PCT No.: PCT/US22/30497

§ 371 Date: Nov. 20, 2023

Related U.S. Application Data
(60) Provisional application No. 63/192,153, filed on May 24, 2021.

(51) Int. Cl. G01N 21/71; G01J 3/02

(52) U.S. Cl. CPC G01N 21/71; G01J 3/0286

(57) ABSTRACT

A highly sensitive thermally stimulated emission (TSE) spectrometer, and a method of conducting spectrometry, are described. Provided is a thermally stimulated emission (TSE) spectrometer comprising a cryostat housing a sample stage in an area; a cooling source configured to lower a temperature of the area to as low as 9 K; a photo-excitation source configured to deliver electromagnetic radiation to a sample on the sample stage; a heat source configured to heat the area; a temperature control unit configured to control the cooling source and the heat source, so as to cool or heat the area; a monochromator configured to receive light emitted from the sample on the sample stage as the area is being heated by the heat source, and emit a specific wavelength or wavelengths of the light; a highly sensitive photomultiplier tube (PMT) configured to detect the light emitted from the monochromator at the specific wavelength or the light emitted directly from the sample covering all wavelengths.

### RELATED APPLICATIONS

This application claims priority to U.S. Provisional Application No. 63/192,153 filed under 35 U.S.C. § 111(b) on May 24, 2021, the disclosure of which is incorporated herein by reference in its entirety for all purposes.

### STATEMENT REGARDING FEDERALLY SPONSORED RESEARCH

This invention was made with no government support. The government has no rights in this invention.

### BACKGROUND

Thermally stimulated luminescence or emission are powerful nondestructive techniques to investigate the active electron/hole traps in materials. Electron/hole traps alter the optical and electrical properties of materials by creating additional recombination pathways, trapping, or providing charge carriers, and modifying exciton dynamics. Understanding the defect/trap dynamics is important for controlling the optoelectronic properties of materials. Measuring donor/acceptor ionization energy is important in semiconductor research. There is a need in the art for new and improved devices and methods for measuring and characterizing donor/acceptor ionization energy and defect/trap dynamics.

### SUMMARY

Provided is a thermally stimulated emission (TSE) spectrometer comprising a cryostat housing a sample stage in an area; a cooling source configured to lower a temperature of the area to as low as 9 K; a photo-excitation source configured to deliver electromagnetic radiation to a sample on the sample stage; a heat source configured to heat the area; a temperature control unit configured to control the cooling source and the heat source, so as to cool or heat the area; a monochromator configured to receive light emitted from the sample on the sample stage as the area is being heated by the heat source, and emit a specific wavelength or wavelengths of the light; a highly sensitive photomultiplier tube (PMT) configured to detect the light emitted from the monochromator at the specific wavelength or the light emitted directly from the sample covering all wavelengths; a photon counter in communication with the photomultiplier tube, the photon counter being configured to count photons detected in the light by the photomultiplier tube; and a data acquisition unit in communication with the photon counter and the temperature control unit, the data acquisition unit being configured to obtain and display information about the photons emitted from the sample as a function of one or more of time, wavelength, and temperature.

In certain embodiments, the cooling source comprises a compressor and heat exchanger with a source of liquid helium. In particular embodiments, the compressor and heat exchanger are configured to deliver liquid helium to the cryostat.

In certain embodiments, the temperature control unit is configured to control the temperature of the cryostat. In particular embodiments, the sample stage is configured to support the sample and a temperature sensor, where the sample stage is in communication with the temperature control unit.

In certain embodiments, the TSE spectrometer further comprises a temperature sensor on the sample stage.

In certain embodiments, the TSE spectrometer further comprises a vacuum pump configured to maintain a desired pressure in the area.

In certain embodiments, the photo-excitation source is configured to excite charge carriers in a sample on the sample stage.

Further provided is a method for conducting spectrometery, the method comprising housing a sample in a cryostat; lowering a temperature in the cryostat to about 9 K; exciting the sample with a photo-excitation source to cause charge carriers in the sample to move into defect states or traps; heating the sample over a period of time; and analyzing photons given off from the sample over the period of time in order to determine characteristics of the defect states or traps.

In certain embodiments, a pressure inside the cryostat is reduced to about 10 mtorr or less before the temperature is lowered. In certain embodiments, a pressure inside the cryostat is reduced to about 1 mtorr.

In certain embodiments, the temperature is lowered by pushing helium inside the cryostat and expanding the helium inside the cryostat in two stages.

In certain embodiments, the analyzed photons are of one wavelength. In certain embodiments, the analyzed photons are of multiple wavelengths.

In certain embodiments, the method comprises devoluting highly overlapped thermally stimulated emission signals with a three-point analysis (TPA) method.

In certain embodiments, the method comprises detecting the photons given off from the sample with a photomultiplier tube.

In certain embodiments, the method comprises restricting photons analyzed with a monochromator to photons having a certain wavelength.

In certain embodiments, the method comprises counting the photons detected by the photomultiplier tube with a photon counter.

In certain embodiments, the sample is excited with UV light.

In certain embodiments, the sample is excited with bandgap light to cause charge carriers to get trapped. In certain embodiments, the sample is excited with sub-bandgap light to allow charge carriers to move from a defect state into a conduction band of the sample.

In certain embodiments, the sample is a semiconductor material. In certain embodiments, the sample is a photonic material. In certain embodiments, the sample is an insulating material.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIGS. 1A-1C: FIG. 1A shows a schematic illustration of a non-limiting example thermally stimulated emission (TSE) spectrometer in accordance with the present disclosure. FIGS. 1B-1C depict illustrations of the working principles of a TSE spectrometer as described herein.

FIG. 2: Schematic diagram showing components of a non-limiting example TSE spectrometer as described herein.

FIG. 3: An isolated TL glow peak. The parameters Iₓ, I_{y}, I_{z}, Tₓ, T_{y}, T_{z}, Aₓ, A_{y}, and A_{z} are defined herein.

FIGS. 4A-4C: TSE glow curve of the Ce:YAG single crystal at 60 K/min heating rate (FIG. 4A). FIG. 4B shows the glow curve for two different irradiation doses. FIG. 4C shows the glow curves for three different heating rates.

FIGS. 5A-5D: Deconvolution of glow curve using a three-point analysis (TPA) method. The figures show the separation of 1 peak (FIG. 5A), 2 peaks (FIG. 5B), 3 peaks (FIG. 5C), and all 9 peaks (FIG. 5D).

FIG. 6: TSL glow curve for emission at two different wavelengths.

FIGS. 7A-7B: TSE glow curve of β-Ga₂O₃ before and after H-anneal (FIG. 7A), and trap level calculation in H-annealed Ga₂O₃ using the initial rise method (FIG. 7B).

FIG. 8: TSE glow curves of GaInO films grown by MOCVD. Each graph was normalized to its maximum intensity to better compare the peak position. The In concentration was varied from zero to 100% which modified the band gap and the position of trap levels. By using the TSE spectrometer, one can easily see the shift in the peak positions corresponding to different energy levels. Such energy levels dictate the optical and electrical properties of these films.

FIGS. 9A-9B: TSE glow curves of GaInO irradiated by the same dose of 50 keV Mg ions. FIG. 9A shows GaInO with 80% In. FIG. 9B shows GaInO with 20% In. The peak position is shifted to higher temperature in 20% In because of its widest band gap as shown in FIG. 10. It is also less intense because of lower defects, indicating that the alloy with higher band gap is much more resistant.

FIG. 10: Optical bandgap vs In percentage in the films grown on sapphire substrates using MOCVD. The optical band gap was obtained from optical absorption spectroscopy measurements.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein is a thermally stimulated emission (TSE) spectrometer for the detection of ultra-shallow traps with very high sensitivity. The TSE spectrometer has the capability to reveal the interaction between trapping defects and recombination centers, and allows for studying exciton dynamics. The TSE spectrometer is a useful tool for semiconductors, as it provides a way to measure shallow donor/acceptor ionization energies and their densities and characteristics. These are important parameters for semiconductor and device development. In photonic and optical materials, the TSE spectrometer provides a tool to study exciton dynamics and chartacterize shallow traps in terms of their density, level, and their characteristics, which strongly impact the emission kinetics and intensity, and dictate the scintillation and luminescence behavior of materials and their performance in lasers, detectors, and illumination devices. The TSE spectrometer advances the study and development of a wide range of materials and is a significant benefit to many different fields.

Point defects are imperfections in the crystal that occur at specific locations or points due to missing and displaced atoms, the presence of impurities, or intentional doping. Point defects often create localized energy states inside the energy band-gap of the material that can significantly modify the optical properties by acting as additional recombination pathways for the electrons and recombination or luminescence centers. Furthermore, these defects can act as donors, acceptors, or deep traps that alter the materials' electrical transport properties. A detailed understanding of the defects and their energy levels in the band-gap is important to control the optical, electrical, and magnetic properties of materials. Hall-effect measurement is a technique for determining the donor/acceptor ionization energy when coupled with a variable temperature unit. However, it is complex and the presence of different donor/acceptor species often makes data analysis challenging. Moreover, the technique has a square geometry constraint, and four electrical contacts must be fabricated on the sample. It is not applicable for powder, insulating, or highly resistive samples that exhibit a low signal-noise ratio. The technique is also less effective for thin films on conductive layers due to the diffusion of current from other layers or for samples with non-uniform thickness. Photoluminescence (PL) technique has also been used to determine the donor ionization energy, however, PL alone cannot always be used to fully characterize the donor/acceptor ionization energy due to the collapse of the exciton and broadening of the peaks. Deep level transient spectroscopy (DLTS) has been used to characterize the defects that create deep levels inside the crystal by injecting majority or minority carriers inside the depletion layer using forward or backward bias and monitoring the capacitance. This technique requires the fabrication of a p-n junction or Schottky barrier on the sample surface, which can be deleterious for samples and not feasible for many cases. Additionally, DLTS is only applicable for a thermal emission rate within a certain detection limit, typically limiting sensitivity to traps within 1 eV of the majority carrier band-edge. As a result, the majority of the defects throughout the wide band-gap materials remains undetected. A different version of DLTS uses monochromatic light as a function of energy to photo-emit the trapped carriers called deep level optical spectroscopy (DLOS), which is also limited in use to deep level defects.

Thermally stimulated luminesence or emission is a technique where the emitted photon, due to the recombination of de-trapped electrons with holes in recombination centers, is detected during the thermal sweep. The traps are saturated by optical injection, and hence, no p-n junction or Schottky barrier needs to be fabricated, and no electric bias needs to be applied. The technique can be used on the samples with any shape and thickness and is feasible for powder samples as well. It has been used in dosimetry, earth sciences, bioimaging, and archaeological or geological samples for age determination, and it is used for defect characterization in crystals.

A relatively low temperature thermoluminescence technique has previously been employed to determine shallow donor/acceptor levels due to the presence of hydrogen in ZnO and Ga₂O₃ crystals using an in-house built spectrometer. However, the spectrometer could only detect the defects that are ionized at temperatures above 77 K (liquid nitrogen temperature). Besides, it was limited by the sensitivity of the charged couple device (CCD) detector. As a result, defect levels below that detection temperature and defects with low concentration remained undetected.

As described in the examples herein, a TSE spectrometer has been developed to identify extremely shallow traps with greater sensitivity. The TSE spectrometer may also be referred to as a cryogenic thermally stimulated emission spectrometer (C-TSeS). The performance of the TSE spectrometer was demonstrated using Ce doped Yttrium Aluminum Garnet, Y₃Al₅O₁₂ (Ce:YAG) single crystal, and a thorough characterization of the traps that ionize above 9K revealing their energy levels, order of kinetics, density, frequency factor, etc., was performed. A three-point deconvolution method was applied to deconvolute the overlapping glow curve to its composite peaks. This overlapping glow curve is common in many materials with energetically close defect levels. It is shown herein that this TSE spectrometer can be used to detect trap levels situated near the conduction or valence band and can be used to determine donor/acceptor ionization energy in luminescent materials. The TSE spectrometer provides a useful tool for the study of semiconductor and photonic materials.

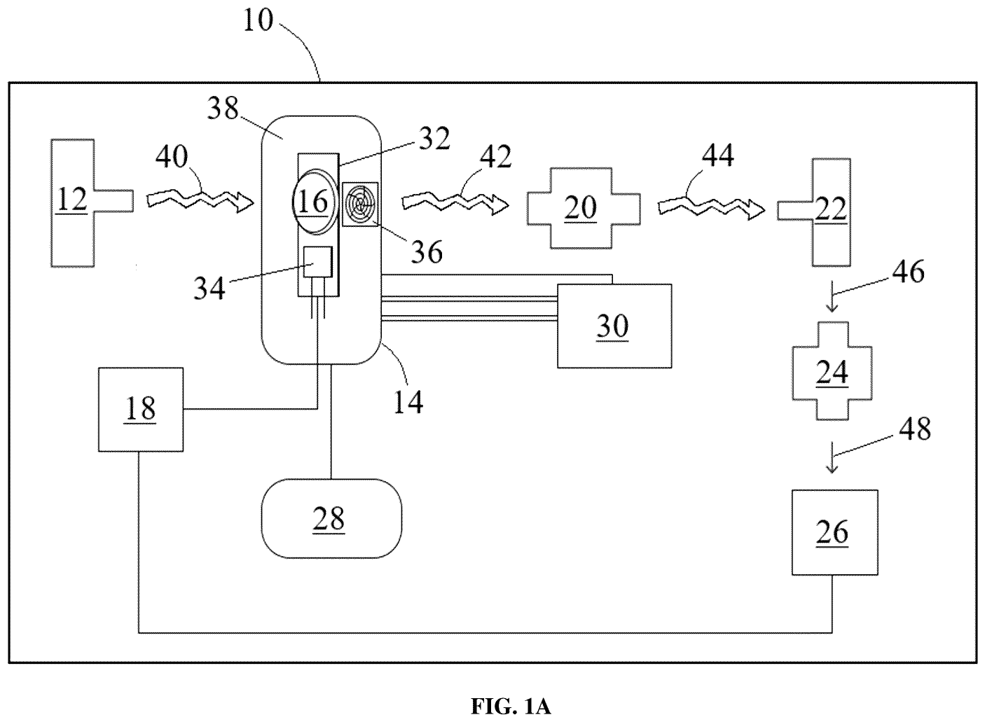

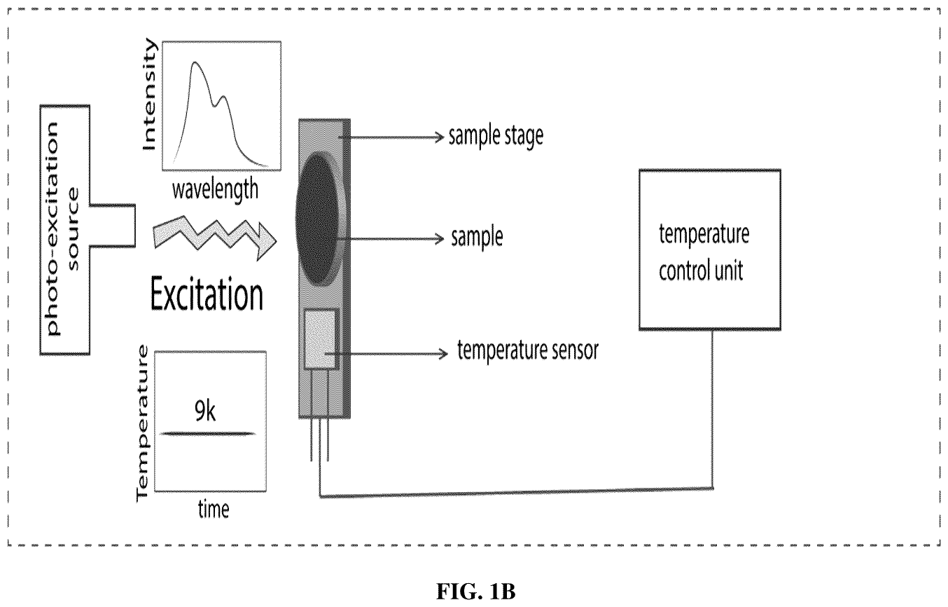

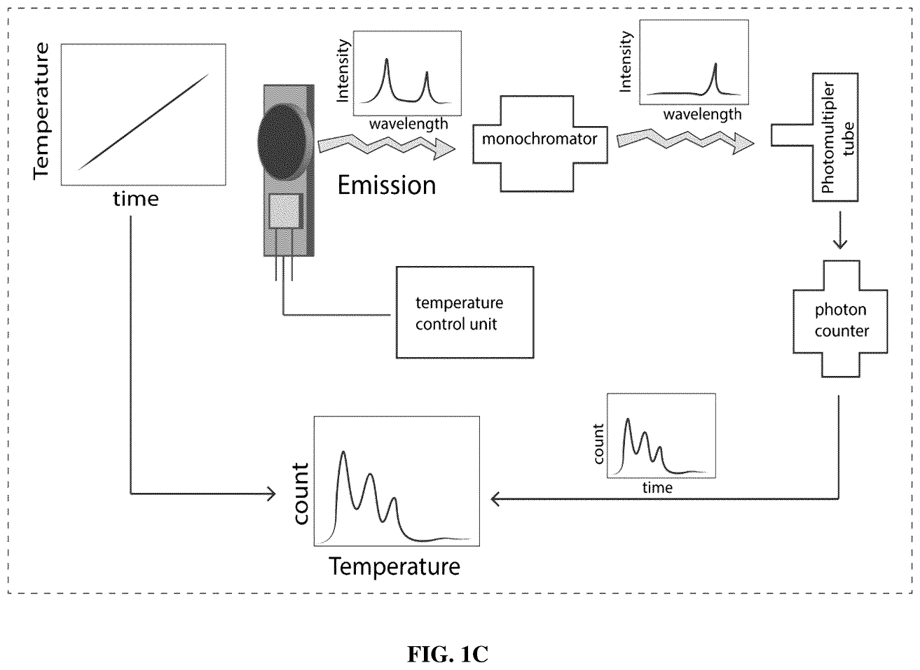

Referring now to FIG. 1A, an example TSE spectrometer 10 in accordance with the present disclosure is illustrated. The TSE spectrometer 10 may include a photo-excitation source 12, a cryostat 14 for housing a sample 16, a temperature control unit 18, a monochromator 20, a photomultiplier tube 22, a photon counter 24, and a data acquisition unit 26. The TSE spectrometer 10 may further include a vacuum pump 28 for maintaining a desired pressure within the cryostat 14, and a compressor and heat exchanger 30 with a liquid helium source for maintaining a desired temperature within the cryostat 14.

Referring still to FIG. 1A, the cryostat 14 houses an area 38 that may have a sample stage 32 on which the sample 16 rests and a temperature sensor 34 is attached. The cryostat 14 may further include a heat source 36 such as an electric heater configured to heat the sample 16 as controlled by the temperature control unit 18. The temperature sensor 34 is configured to detect the temperature of the area 38 and/or the sample stage 32 so as to determine the temperature the sample 16 is being heated or cooled to. Pressurized helium may be delivered to the cryostat 14 from the compressor and heat exchanger 30 as controlled by the temperature control unit 18. The vacuum pump 28 is configured to reduce the pressure within the cryostat 14 to a level sufficient to cool the sample 18 using the pressurized helium to a temperature as low as 9 K. In one non-limiting example, the vacuum pump 28 reduces the pressure within the cryostat 14 to about 10 mtorr.

The photo-excitation source 12 can be any source of light 40, such as a deuterium lamp, one or more light emitting diodes, or a UV light. The TSE spectrometer 10 may also include variable energy photoexcitation sources 12 with variable wavelengths.

The monochromator 20 is a device that transmits a mechanically selectable narrow band of wavelengths of light chosen from a wider range of wavelengths available at the input. The monochromator 20 receives light 42 emitted from the sample 16, and transmits light 44 having a narrower band of wavelengths to the photomultipler tube 22.

The photomultiplier tube 22 is a vacuum tube that is an extremely sensitive detector of light in the ultraviolet, violet, and near-infrared ranges of the electromagnetic spectrum, emitting a pulse of signal 46 when a photon is detected. At a basic level, a photomultiplier tube 22 is a photocell with multiple amplification stages. An emitted electron from a photocathode is accelerated by a voltage drop towards an electrode (the first dynode) which on impact produces a secondary electron shower, and this process is repeated for multiple stages until the anode is reached, by which point the original current has been amplified. The photomultiplier tube 22 multiplies the current produced by incident light by as much as 100 million, or 10⁸, times, which enables individual photons to be detected when the incident flux of light is low. The photomultiplier tube 22 receives the light 44 transmitted by the monochromator 20, and creates a current 46 based on the transmitted light 44 that is then transmitted to the photon counter 24.

The photon counter 24 may be, for example, a digital photon counter. However, other types of photon counters 24 are possible and encompassed within the scope of the present disclosure. The photon counter 24 receives the current 46 from the photomultiplier tube 22, converts the current 46 to a photon count, and transmits a signal 48 containing the photon count to the data acquisition unit 26.

The data acquisition unit 26 can be any suitable computing device in communication with both the photon counter 24 and the temperature control unit 18, so as to receive input regarding both the light emitted from the sample 16 and the temperature of the sample 16 at the time the light was emitted. The data acquisition unit 26 can produce and display information involving the intensity of light given off by the sample 16 at particular temperatures as a function of time or wavelength. The data acquisition unit 26 may be in wireless communication with one or more devices such as smart phones or tablets, including through a cloud-based network.

The working principles of the TSE spectrometer can be explained as follows. The measurement begins with the excitation of the sample at low temperature (9K), as shown in FIG. 1B. A photoexcitation source is used to excite electrons from the valence band or from defect levels to the conduction band. The excited electrons recombine at the recombination centers via radiative and non-radiative pathways. During this process, electrons may become trapped at defect centers. Depending on the defect energy level and capturing/emission cross-section, the electrons remain trapped at low temperature if no perturbation occurs. The trapped electrons can be then released by the thermal excitation at different temperatures depending on the thermal activation energy of the defects. The sample is heated at a linear rate as shown in FIG. 1C. Thermally released electrons recombine at the recombination centers. In the case of radiative recombination, photons of a specific wavelength are emitted. The emission is collected and analyzed as a function of temperature to reveal the defect characteristics (FIG. 1C).

Many of the trap parameters such as energy level, caption cross-section, and density can be obtained from the temperature dependent emission known as a glow curve. The photon counts and temperature data as a function of time can be combined to construct glow curves for the analysis of defect dynamics. In the presence of many traps with several transition levels, the glow curve is often a convolution of several peaks, and hence a rigorous analysis is needed to deconvolute the emission curve to its individual peaks and extract the corresponding trap parameters. As a non-limiting example, a three-point analysis (TPA) method can be utilized to analyze the complex glow curves that are obtained with the TSE spectrometer. Because of high sensitivity and low temperature capability down to 9K, the TSE spectrometer can produce a vast number of convoluted peaks, as shown in the examples herein.

To better understand the TPA method, some background of thermoluminescence (TL) theory is helpful. The mathematical modeling of TL is constructed from the Randall and Wilkins model for the simple case where no significant re-trapping of electrons occurs after the thermal emission of electrons from the traps. The intensity of the emitted photons due to the recombination of the thermally released electron with the recombination center (hole trap) can be described as follows:

$$I ( T ) = {n}_{0} \frac{s}{β} exp \{ - \frac{{E}_{D}}{kT} \} \times exp \{ - \frac{s}{β} {\int }_{{T}_{0}}^{T} exp \{ - \frac{{E}_{D}}{{kT}^{′}} \} {dT}^{′} \qquad ( 1 )$$

where n₀ is the total number of trapped electrons at time t=0, β is the constant heating rate, s is the frequency factor and is considered as a constant in the simplified model, T is the absolute temperature, k is Boltzmann constant, and E_{D} is the thermal activation energy of the defect. The model is described as first order kinetic. Initially, the peak intensity is dominated by the first exponential half of equation (1), and the last half can be neglected. As a result, if ln(I) is plotted as a function of 1/T for the first 10% of the maximum intensity of the glow peak, a straight line is obtained with the slope of −E_{D}/k from which the activation energy, E_{D}, can be calculated. At temperature Tₘ, the temperature at which the intensity of the glow peak is maximum, (dI/dT) of equation (1) becomes zero and one can find:

$$\frac{β {E}_{D}}{{kT}_{m}^{2}} = s exp \{ - \frac{{E}_{D}}{{kT}_{m}} \} \qquad ( 2 )$$

Equation (2) can be rearranged as follows:

$$ln \frac{{T}_{m}^{2}}{β} = ( \frac{{E}_{D}}{k} ) \frac{1}{{T}_{m}} - ln ( \frac{kS}{{E}_{D}} ) \qquad ( 3 )$$

Thus, the activation energy E_{D} can also be calculated from the slope of the ln(T²/β) vs. 1/Tₘ line by heating the sample at various rates. The equation was derived for first order kinetics; however, the equation can also be used to obtain E_{D} with acceptable accuracy in some non-first order kinetics.

A similar equation to equation (1) has been derived for the second order kinetics where significant re-trapping occurs, assuming that the trap is far from being saturated. The intensity is given in the form:

$$I ( T ) = \frac{{n}_{0}^{2} s}{N β} exp \{ - \frac{{E}_{D}}{kT} \} \times {[ 1 + \frac{{n}_{0} s}{N β} {\int }_{{T}_{0}}^{T} exp \{ - \frac{{E}_{D}}{{kT}^{′}} \} {dT}^{′} ]}^{- 2} \qquad ( 4 )$$

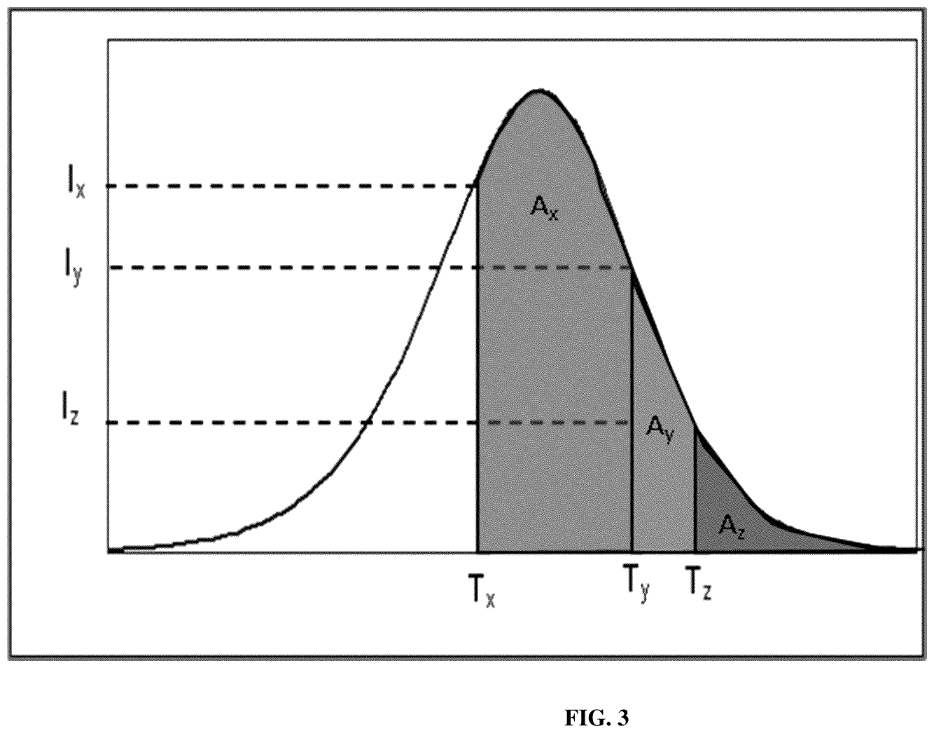

N (cm⁻³) is the concentration of the electron traps. Finally, the intensity in the case of general order kinetics is given as:

$$l ( T ) = \frac{{n}_{0} {S}^{″} exp ( - {E}_{D} / {kT}_{m} )}{{( 1 + \frac{( b - 1 ) {S}^{″}}{β {\int }_{{T}_{0}}^{T} exp \{ - \frac{{E}_{D}}{{kT}^{′}} \} {dT}^{′}} )}^{\frac{b}{b - 1}}} \qquad ( 5 )$$

where S″=S(nₒ/N)^{b-1}, and b is the parameter related to the re-trapping probability. Several computer programs have been developed to fit the glow curve and calculate the trap parameters when the curve consists of a single peak. Nevertheless, the situation is more complicated when the peaks are overlapped, which is a typical case for many luminescent materials. Deconvolution and analysis of these peaks to determine the trap parameters with high accuracy are quite challenging. As mentioned above, TPA technique was utilized in the examples herein to deconvolute the glow curve and determine the trap parameters from its peaks. These parameters include the order of kinetics b, the activation energy E_{D}, the initial concentration of the trapped ions no, and frequency factor S or S″ for first and general order kinetics, respectively. The technique has been successfully used to perform analysis for TL glow curves of two, three, four, and five glow peaks. The TPA technique starts with selecting a set of three points, x, y, and z, in other words, three temperatures such as Tₓ, T_{y}, and T_{z}, as illustrated in FIG. 3. These points are randomly selected from the glow curve near the high-temperature peak, considering the overlapping conditions with y=(Iₓ/I_{y}) and z=(Iₓ/I_{z}). The intensities Iₓ, I_{y}, and I_{z}, and the area under the curve Aₓ, A_{y}, and A_{z}, between the corresponding temperatures Tₓ, T_{y}, and T_{z}, and the final temperature of the glow peak T_{f}, are obtained, then the process of trapping parameters determination begins. By defining the above values, the order kinetics b can be determined numerically using the following equation:

$$b = \frac{{T}_{y} [ {T}_{x} - {T}_{z} ] ln ( y ) - {T}_{z} [ {T}_{x} - {T}_{y} ] ln ( z )}{{T}_{y} [ {T}_{x} - {T}_{z} ] ln ( {A}_{x} / {A}_{y} ) - {T}_{z} [ {T}_{x} - {T}_{y} ] ln ( {A}_{x} / {A}_{y} )} \qquad ( 6 )$$

In sequence, the activation energy can be calculated from the expression:

$${E}_{D} = [ ln ( y ) - b ln ( {A}_{x} / {A}_{y} ) ] ( \frac{{kT}_{x} {T}_{y}}{{T}_{x} - {T}_{y}} ) \qquad ( 7 )$$

or from the expression:

$${E}_{D} = [ ln ( z ) - b ln ( {A}_{x} / {A}_{z} ) ] ( \frac{{kT}_{x} {T}_{z}}{{T}_{x} - {T}_{z}} ) \qquad ( 8 )$$

Then the value of S in the case of first order kinetics is calculated from:

$$S = ( \frac{β E}{{kT}_{m}^{2}} ) exp ( E / {kT}_{m} ) \qquad ( 9 )$$

Alternatively, S″ in case of the general order can be obtained as:

$${S}^{″} = \frac{β E exp ( E / {kT}_{m} )}{[ {bkT}_{m}^{2} ] - ( b - 1 ) E ϕ exp ( E / {kT}_{m} )} \qquad ( 10 )$$

where ϕ can be given as:

$$ϕ = {\int }_{{T}_{0}}^{T} exp ( - E / {kT}^{′} ) {dT}^{′} \qquad ( 11 )$$

After the trap parameters are determined for the peak, the values simulate the peak using the general order equation, equation (5). The simulated peak is then subtracted from the experimental glow curve to reveal the lower temperature peak. This sequence is repeated to deconvolute the overlapped glow curve and determine the trap parameters.

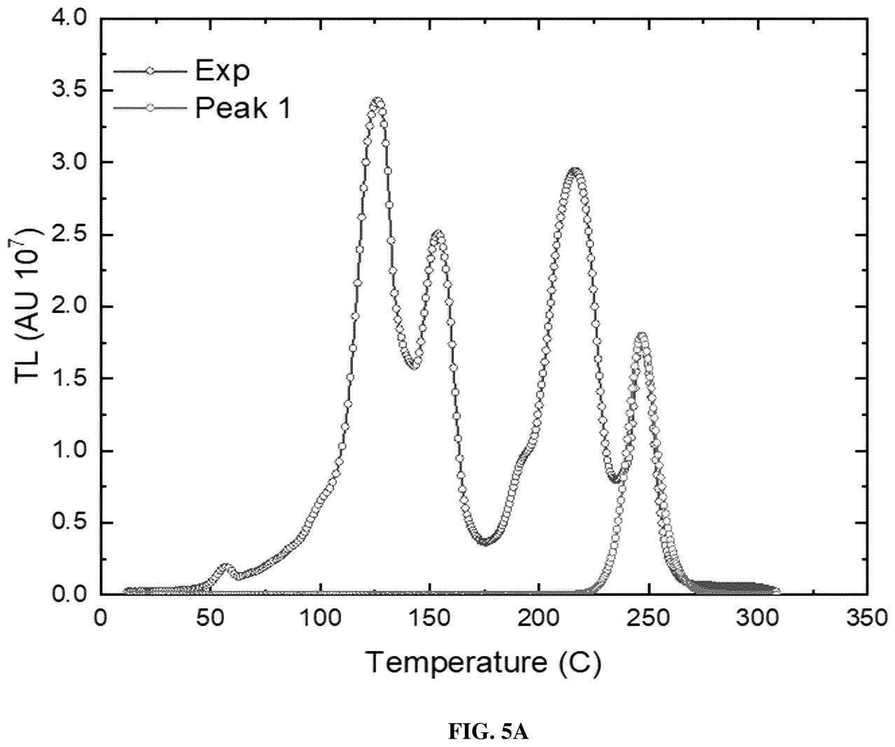

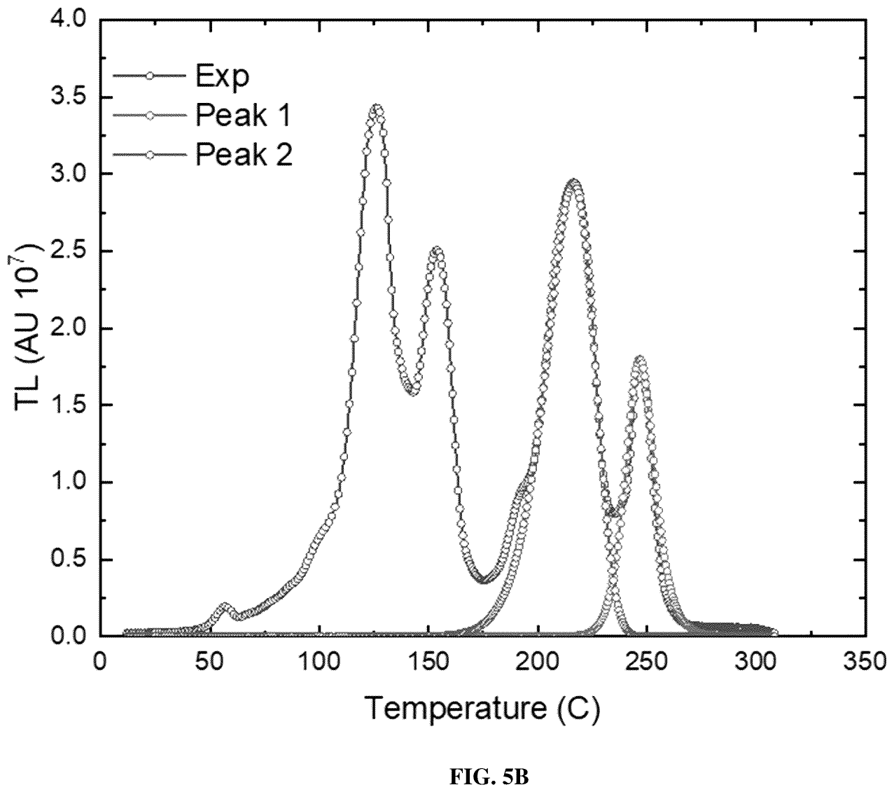

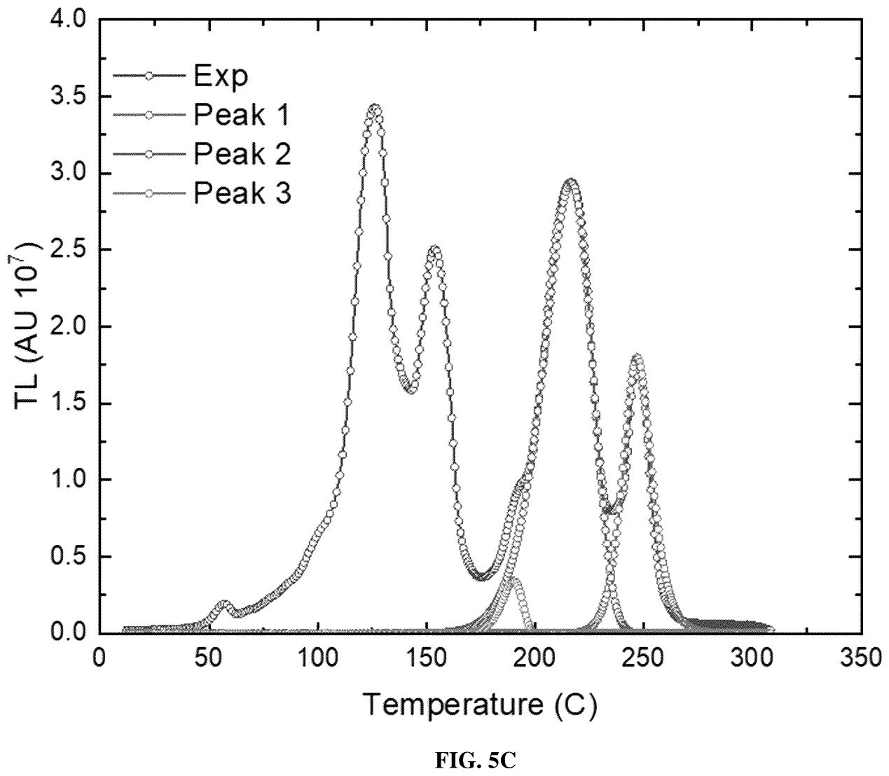

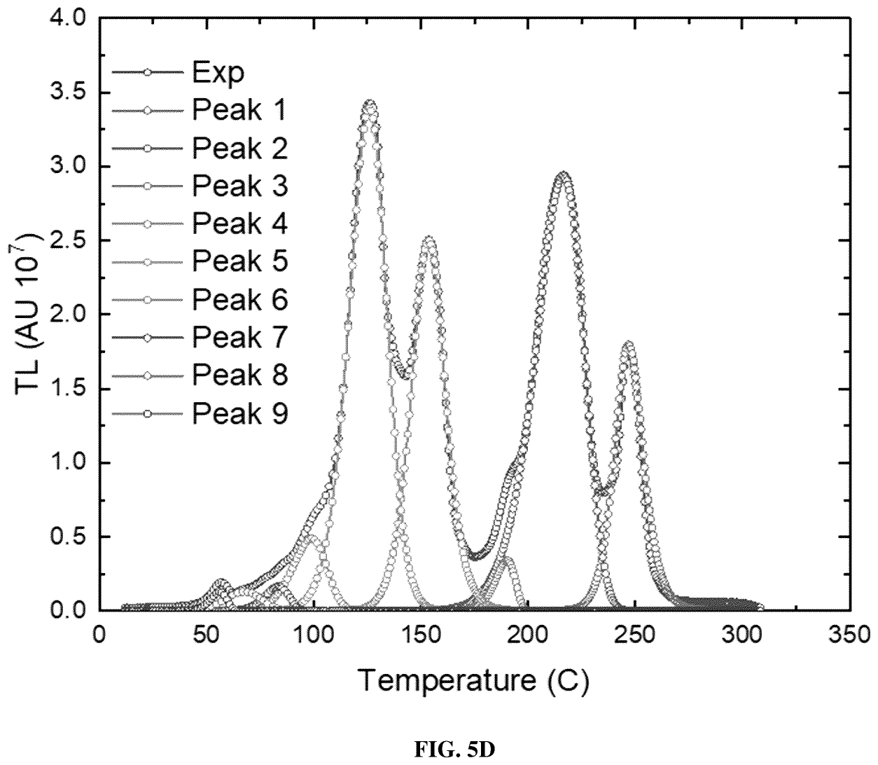

FIGS. 5A-5D show the deconvolution of the peaks using TPA method, which starts from the most right peak (highest temperature peak) and gradually deconvolutes the other peaks by subtracting the previous fitted ones. In the examples herein, the best fit between the deconvoluted and the original experimental data was found by separating 9 peaks, which is shown in FIG. 5D.

The TSE spectrometer described herein provides the capability to reveal the interaction between trapping defects and recombination centers, and to study exciton dynamics. The TSE spectrometer has the capability to collect emission at different selected wavelengths, which is an additional advantage when more than one recombination center is present. The TSE spectrometer is a sensitive spectrometer, covering the low temperature regime from 9 K to room temperature and above, and can be used to investigate and characterize traps and transition levels in materials. This provides a powerful technique to study exciton dynamics in photonic materials and reveal their interesting characteristics.

### EXAMPLES

### Example I

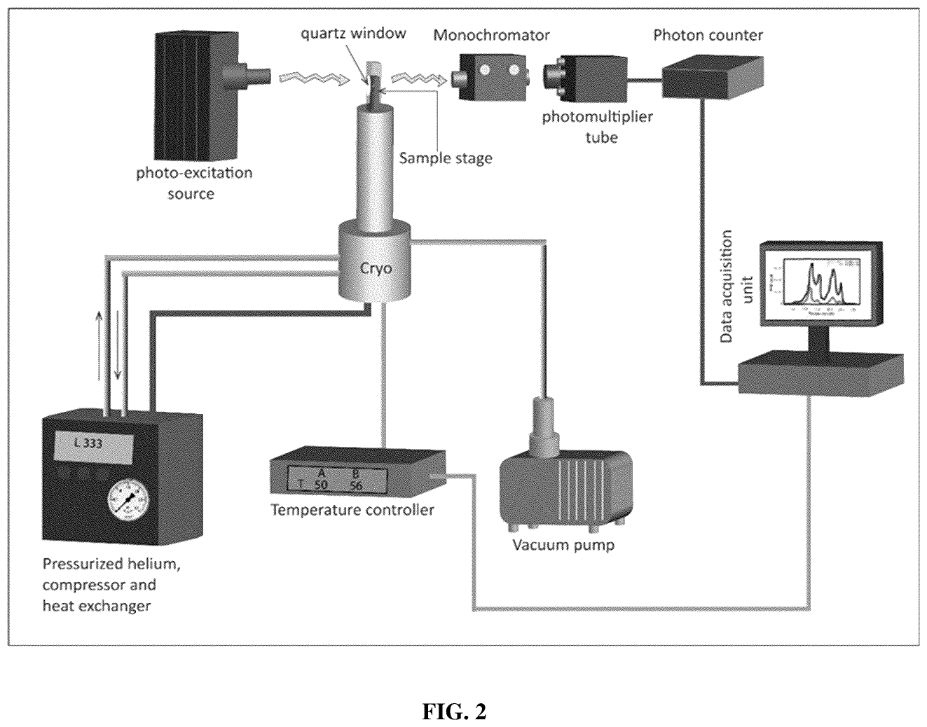

This example describes the development of a highly sensitive thermally stimulated emission (TSE) spectrometer for the low temperature regime of 9 K-325 K to detect and characterize shallow traps in band-gap materials with enhanced sensitivity. A TSE spectrometer as illustrated in FIG. 2 was built and evaluated. The TSE spectrometer provides a powerful characterization tool for a wide range of electronic and photonic materials. The technique is ideal where electrical methods cannot be used for donor/acceptor characterization, as in powder, irregular shape and thickness, insulating materials, and high resistive samples. The performance of the TSE spectrometer was tested by measuring Ce doped Y₃Al₅O₁₂ single crystal. The measurements identified several shallow levels that cannot be detected with conventional thermoluminescence systems. A sophisticated data analysis technique based on the three-point analysis (TPA) approach was applied to deconvolute the highly overlapped TSE signals. The developed ultra-low temperature TSE spectrometer, optionally together with the TPA deconvolution method, provides a unique tool for measuring donor and acceptor ionization energies and densities in luminescent semiconductors and studying exciton dynamics in photonic materials. This advances material characterization and development for a wide range of applications including lasers, electronic and illumination devices, and detectors for medical diagnostic and nuclear applications.

FIG. 2 depicts the components of the example TSE spectrometer. The system includes a temperature control unit, a photoexcitation unit, and an emission collection unit. The sample was placed inside a stainless-steel cryostat chamber on a copper sample stage with a central hole of quartz lens. The cryostat chamber in this example TSE spectrometer was custom designed for the TSE spectrometer, and was built by Advanced Research Systems, Inc. The cryostat chamber tip was equipped with two quartz windows of high transmission in the deep UV region to near IR, as shown in FIG. 2. This arrangement allows the collection of photons in transmission geometry from different angles of the sample. The chamber was also equipped with an additional cover having four quartz windows that allow the collection of emission from the surface of the sample, which may be necessary if the surface layers of the sample strongly absorb UV as in the case of ZnO. The temperature sensor was placed right below the sample on the sample stage to control and monitor the temperature. At the foot of this sample stage there was an electric heater placed to heat up the sample at the desired rate. The temperature was controlled using a Lake Shore Cryotronics Inc. Model 335 temperature controller. The cryostat chamber was connected to a pressurized helium storage, compressor, heat exchanger, and a vacuum pump. A rotary vane pump (5-21 m³/h) from Pfeiffer vacuum (Pascal 2005 SD) was used. The chamber pressure was reduced to 10 mtorr before helium was pushed and expanded inside the chamber in two stages that lower the temperature of the sample stage down to 9K. The sample was irradiated at 9K in the dark using a wide energy photoexcitation source such as deuterium lamp (Newport, Model 60000). The TSE spectrometer was also equipped with a variable energy photoexcitation source and light emitting diodes with variable wavelength to excite electrons only from defect levels when it is relevant for the study. After the irradiation, the sample was heated linearly at the desired rate using the electric heater and the emission was collected with a monochromator (lambda LEOI-92), photomultiplier tube (Hamamatsu, Type H10682-01), and a digital photon counter (Hamamatsu, Type C8855-01). A computer was configured to collect and store the photon counts and temperature data as a function of time, which were then combined to construct the glow curves for the analysis of defect dynamics.

### Performance Evaluation

The performance of the TSE spectrometer was evaluated through the characterization of the traps in a cerium-doped yttrium aluminum garnet (Ce:YAG) single crystal. YAG was selected because it represents one of the most widely investigated materials because of its applications as detectors, laser host materials, and phosphors. YAG exists as a complex cubic structure oxide in which Al³⁺ ions occupy tetrahedral and octahedral sites in the ratio of 3:2, and Y³⁺ ions occupy dodecahedral sites. A relatively stable lattice and good mechanical strength at high temperatures make YAG an excellent host for rare-earth ions. Notably, Ce:YAG plays an important role in InGaN light-emitting diodes as it absorbs a part of the blue light from InGaN and emits yellow light, which combines and appears as white light, making it an instrumental candidate for the technology of white light-emitting diodes (WLEDs). Defect-induced luminescence studies featuring thermally stimulated luminescence, radioluminescence, and X-ray induced luminescence (XRIL) spectroscopies revealed the presence of several defect sites and luminescence centers, both shallow and deep, throughout the band-gap.

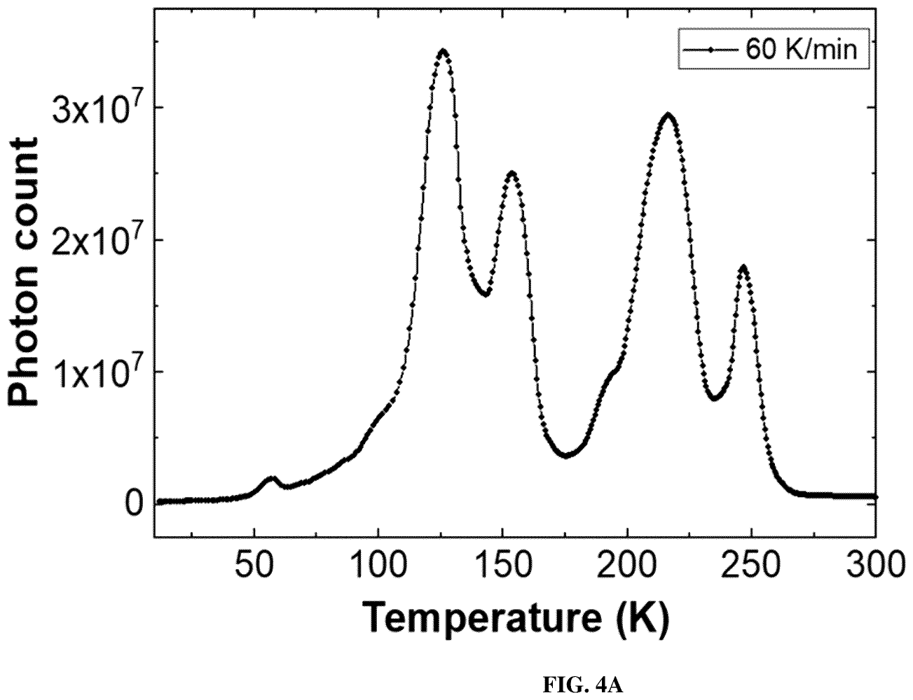

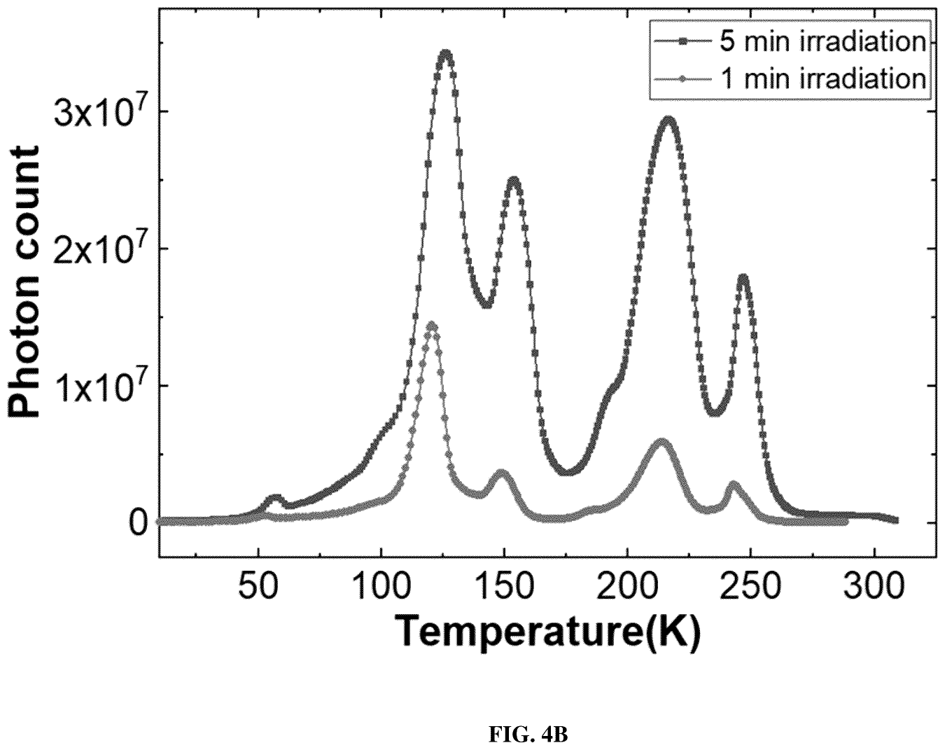

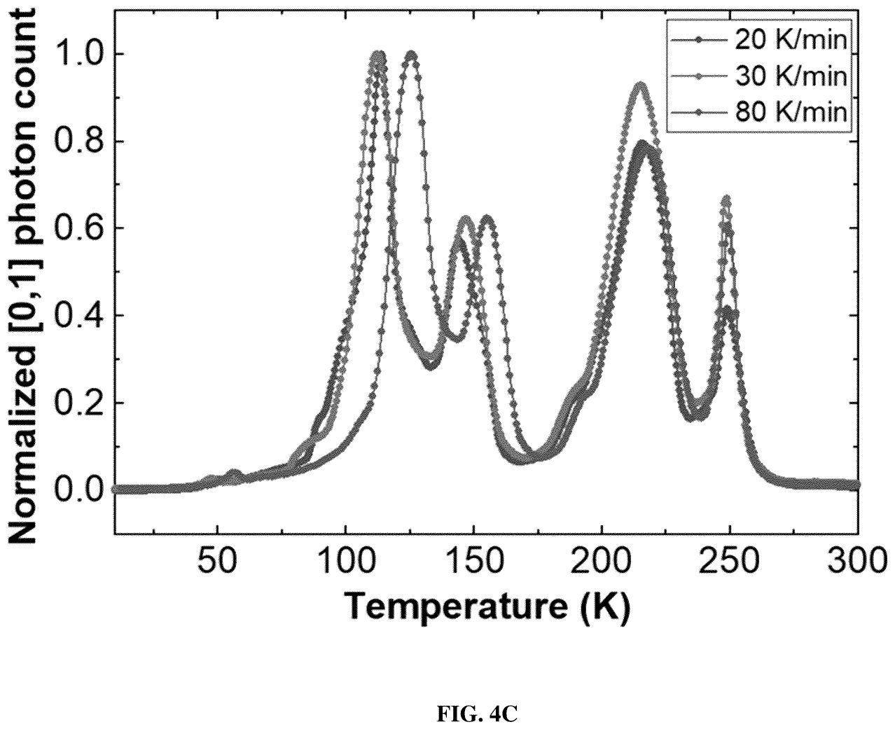

FIGS. 4A-4B depict the glow curve of a Ce:YAG single crystal constructed from the data collected using the TSE spectrometer described above. FIG. 4A shows the glow curve for 5 min irradiation and 60 K/min heating rate collected with a monochromator set at 525 nm. The 525 nm emission is associated with the transition from 4f₀5d₁ to ²f_{5/2}, ²f_{7/2} levels in the Ce atom. FIG. 4A exhibits several distinct peaks, however, the peaks are partially overlapped which is a common phenomenon for many glow curves. To analyze the glow peaks, the curve should be deconvoluted. FIG. 4B presents the glow curve obtained from two different irradiation times. The intensity of the peaks for 5 min irradiation is much larger than the 1 min, however, it does not change much with further increase in irradiation time, which indicates the saturation of the traps. FIG. 4C shows the glow curve at three different heating rates. According to the mathematical model of the TL phenomena, the maximum peak temperature (Tₘ) of the glow peaks should move to a higher temperature with increasing heating rate. However, in the case of overlapped peaks and non-first order phenomena, the glow curve does not always follow the trend, which makes it difficult to use equation (3) to estimate the defect parameters from different heating rates method. FIG. 4C shows the same complications. Therefore, it is important to use an alternative method to deconvolute the glow curve and analyze the peaks. In this example, the TPA method, described above, was employed. FIGS. 5A-5D show the deconvoluation of the glow curve.

Finally, the peak parameters were obtained numerically using equations 6-11 with a computerized program, and are presented in Table 1 below. The activation energy of the defects was found to be in the range of 41 meV to 1.14 eV. The detection of extremely shallow (peak 6-peak 9), low density defects by the system clearly demonstrates its outstanding capabilities in detecting and fully characterizing shallow donor/acceptor levels. The shallow levels in Ce:YAG have been reported to be related to Fe and hydrogen impurities while the deep levels to Al and oxygen vacancies. Antisite defects may also provide deep and shallow levels. The order of kinetics of the peaks is also reported in Table 1. All the peaks show the order of kinetics in between 1 and 2. Peak 1 exhibits the highest order of kinetics of 1.977 while peaks 2, 3, 6, 7, 8, and 9 show almost first order kinetics. The highest concentration of traps is 8.470×10⁸ cm⁻³, associated with peak 2 with 0.354 eV activation energy. The lowest concentration is 2.911×10⁷ cm⁻³, associated with the defect level of 0.041 eV.

TABLE 1
Defect parameters of Ce:YAG single crystal

| | | | | | |
|---|---|---|---|---|---|
| | Order of | | Activation | | peak |
| Defect density, | kinetics, | | energy, | Frequency | temperature, |
| nₒ (cm⁻³) | b | S″ | E_{D} (eV) | factor, S | Tₘ (K) |

Peak 1

| | | | | | | |
|---|---|---|---|---|---|---|
| Standard error | 3.060 × 10⁶ | 0.014 | 1.466 × 10²² | 0.007 | 1.514 × 10²² | |
| values | 3.163 × 10⁸ | 1.977 | 5.356 × 10²² | 1.145 | 5.540 × 10²² | 246.87 |

Peak 2

| | | | | | | |
|---|---|---|---|---|---|---|
| Standard error | 8.611 × 10⁶ | 0.018 | 1.038 × 10⁶ | 0.001 | 1.036 × 10⁶ | |
| values | 8.470 × 10⁸ | 1.036 | 1.521 × 10⁷ | 0.354 | 1.526 × 10⁷ | 216.43 |

Peak 3

| | | | | | | |
|---|---|---|---|---|---|---|
| Standard error | 6.096 × 10⁵ | 0.017 | 5.120 × 10¹⁶ | 0.005 | 5.118 × 10¹⁶ | |
| values | 4.165 × 10⁷ | 1.023 | 1.830 × 10¹⁷ | 0.674 | 1.832 × 10¹⁷ | 189.79 |

Peak 4

| | | | | | | |
|---|---|---|---|---|---|---|
| Standard error | 6.821 × 10⁶ | 0.041 | 2.714 × 10⁸ | 0.001 | 3.012 × 10⁸ | |
| values | 5.221 × 10⁸ | 1.653 | 6.470 × 10⁹ | 0.324 | 6.780 × 10⁹ | 153.64 |

Peak 5

| | | | | | | |
|---|---|---|---|---|---|---|
| Standard error | 5.848 × 10⁶ | 0.024 | 7.928 × 10⁴ | 0.001 | 8.295E+04 | |
| values | 7.699 × 10⁸ | 1.293 | 6.475 × 10⁵ | 0.168 | 6.682 × 10⁵ | 126.01 |

Peak 6

| | | | | | | |
|---|---|---|---|---|---|---|
| Standard error | 1.882 × 10⁶ | 0.030 | 4.146 × 10³ | 0.002 | 4.203 × 10³ | |
| values | 9.967 × 10⁷ | 1.061 | 1.779 × 10⁴ | 0.102 | 1.794 × 10⁴ | 99.18 |

Peak 7

| | | | | | | |
|---|---|---|---|---|---|---|
| Standard error | 1.310 × 10⁵ | 0.006 | 3.637 × 10⁴ | 0.001 | 3.671 × 10⁴ | |
| values | 2.392 × 10⁷ | 1.036 | 2.547 × 10⁵ | 0.102 | 2.558 × 10⁵ | 83.521 |

Peak 8

| | | | | | | |
|---|---|---|---|---|---|---|
| Standard error | 4.191 × 10⁵ | 0.006 | 1.379 × 10¹ | 0.001 | 1.383 × 10⁷ | |
| values | 2.911 × 10⁷ | 1.013 | 1.111 × 10² | 0.041 | 1.113 × 10² | 68.06 |

Peak 9

| | | | | | | |
|---|---|---|---|---|---|---|
| Standard error | 2.279 × 10⁵ | 0.006 | 9.268 × 10⁴ | 0.001 | 9.272 × 10⁴ | |
| values | 1.259 × 10⁷ | 1.024 | 3.858 × 10⁵ | 0.069 | 3.869 × 10⁵ | 56.22 |

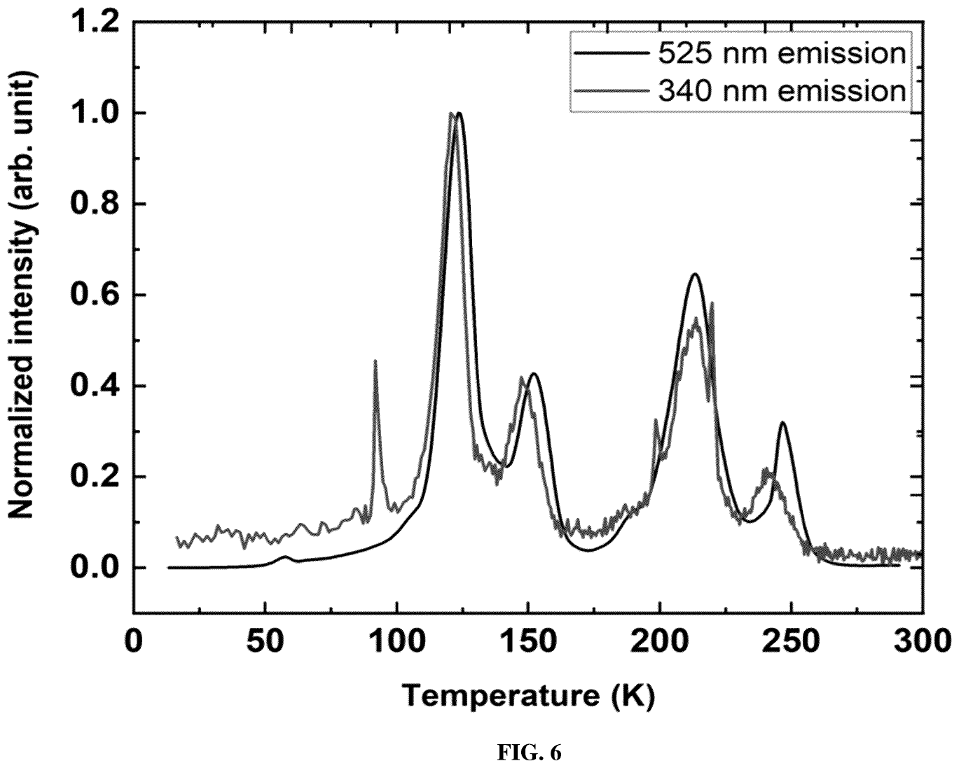

The TSE spectrometer has the capability to collect emission at different selected wavelengths, which is an additional advantage when more than one recombination center is present. The TSE spectrometer allows one to study the interaction between the traps and recombination centers. To demonstrate this capability, the glow curve was constructed for two different wavelengths setting for Ce:YAG crystal, as shown in FIG. 6. The emission for 525 is much more intense than the emission at 340 nm, which is why the photon counts are normalized to compare the glow peaks. The 340 nm emission is known to be associated with self trap excitons and antisite Y_{Al}³⁺, which are native defects in YAG. As evident from FIG. 6, the two emission peaks coincide, except for an additional sharp emission peak—below 100 K—which appeared only with 340 nm. The similarity of the two glow curves is an indication that the detected traps are the same defects but interacting with two different recombination centers and thus emitting at two different wavelengths. The reason behind the additional peak below 100 K for 340 nm emission wavelength is due to spatial proximity between the trap and recombination center.

To further demonstrate the capability and utility of the spectrometer in different fields and for different material systems, it was used to detect and measure a trap level in Ga₂O₃, which is a useful semiconductor for high power devices and optoelectronics.

Undoped β-Ga₂O₃ single crystals grown by Edge-defined Film-fed Growth method (EFG) propagating parallel to (010) were purchased from Tamura Inc., Japan, and cut into small pieces of (5 mm×5 mm×0.5 mm). One sample was annealed in hydrogen gas in a specialized quartz ampoule to populate a defect and trap level in the Ga₂O₃. The ampoule containing the sample was subjected to high vacuum before filling up with hydrogen gas at 580 torr pressure and sealed. Then it was placed in an oven and annealed at 950° C. for two hours.

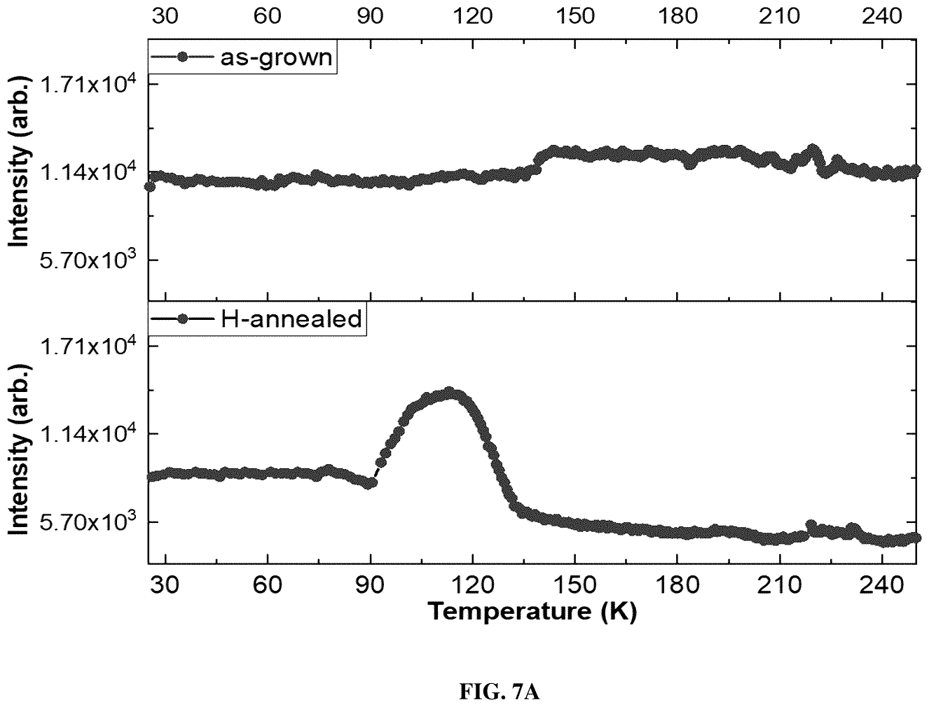

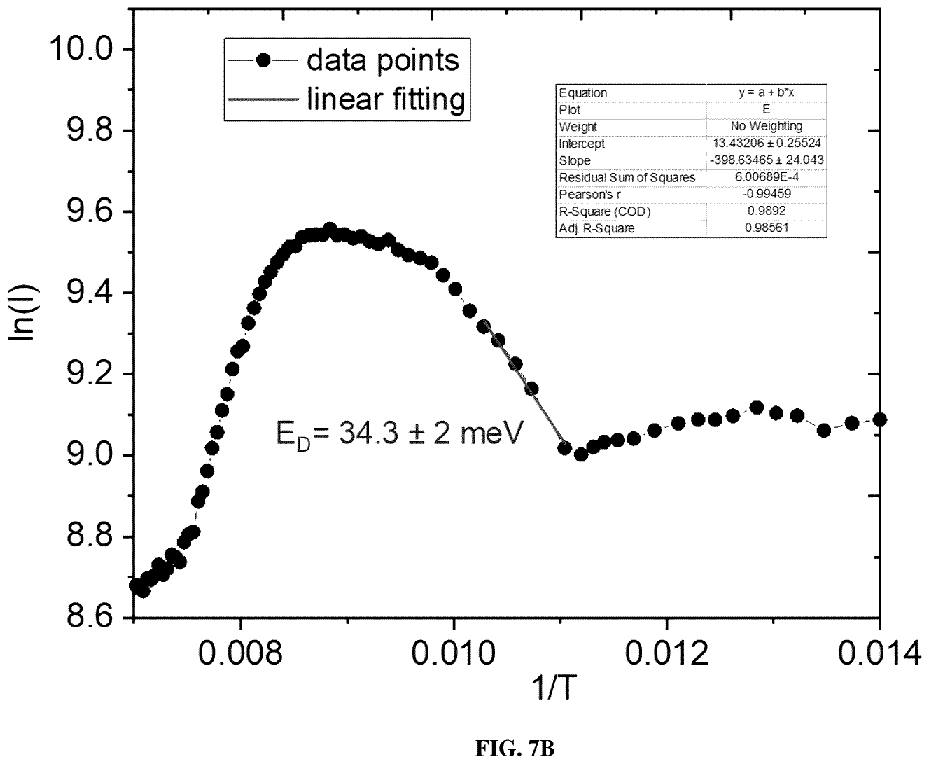

The TSE measurements were performed on the as-grown and annealed samples to investigate the defect level introduced or modified due to the hydrogen incorporation. The two samples were irradiated for 15 minutes at 9K with a deuterium lamp to saturate the defect states with electrons. After that, the temperature was increased linearly to release the electrons which would eventually recombine with the radiative recombination center and emit photons of characteristic wavelengths as described above. The monochromator was set to 695 nm, as β-Ga₂O₃ has a red emission centered at this wavelength. The TSE from the as-grown and treated samples in FIG. 7A indicates the creation of a shallow trap level after H-treatment. The activation energy (the trap level) of the populated defect center E_{D} is 34.3±3 meV, calculated using the initial rise method as shown in FIG. 7B.

### Conclusion

In summary, a sensitive TSE spectrometer covering a low temperature regime from 9 K to room temperature and above was developed and used to investigate and characterize traps and transition levels in materials. The TSE spectrometer is suitable for identifying donor/acceptor levels and determining the ionization energy and intensity of shallow donors/acceptors in semiconductors. It also provides a powerful technique to study exciton dynamics in photonic materials and reveal their interesting characteristics. To test its performance, the TSE emission of a Ce:YAG single crystal was collected, and it was shown that the system can be used to detect and analyze extremely shallow defects with low density. A modified TPA method was used to deconvolute and analyze the overlapped glow peaks and determine all trap parameters. The spectrometer was also used to detect and characterize a shallow trap created in Ga₂O₃ by H-anneal, demonstrating its capabilities in measuring traps in semiconductor as well as in photonic materials.

### Example II

The TSE spectrometer described in Example I has been found to be a powerful tool for characterizing thin films of semiconductors and oxides. The TSE spectrometer was employed to study a wide range of effects and phenomena in GaO films.

### Effect of Band Gap Engineering on the Shallow and Deep Levels

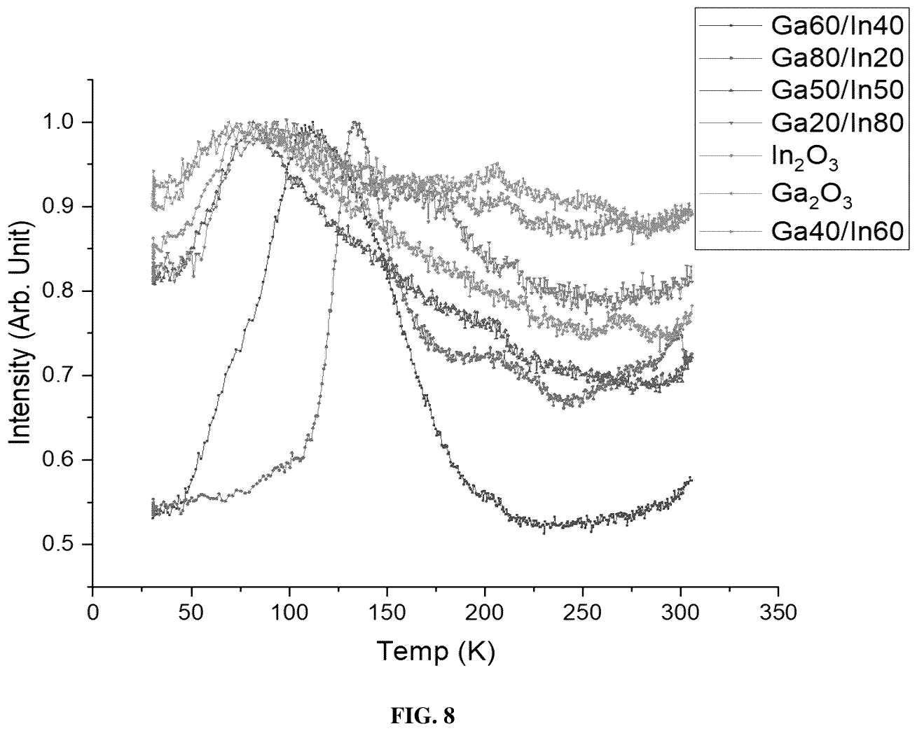

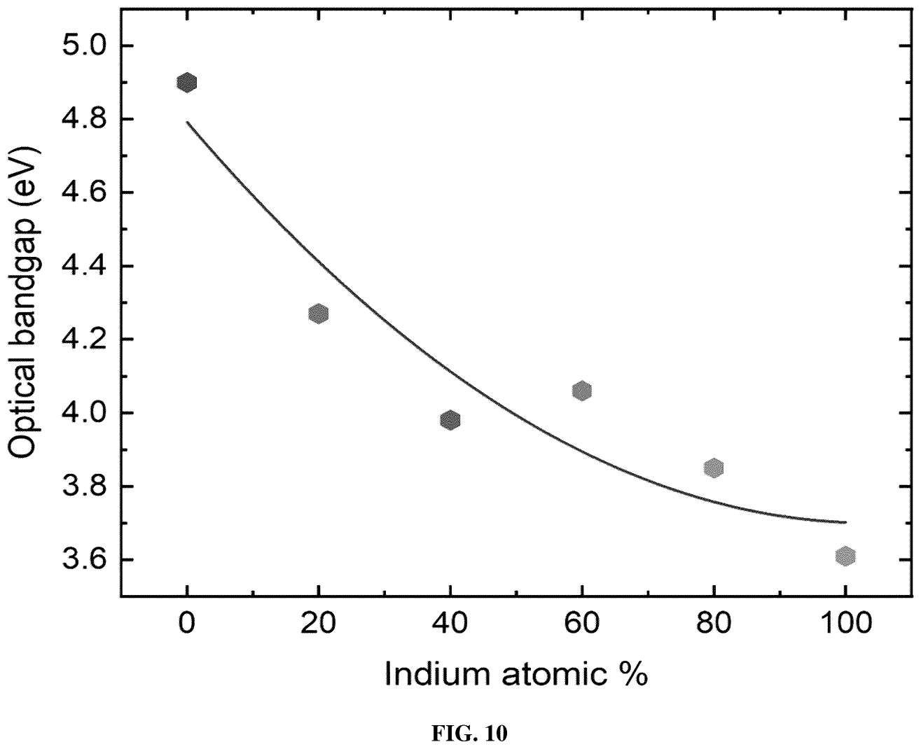

Epitaxial GaO and GaInO films were grown by metal organic chemical vapor deposition and their trap levels were investigated using the TSE spectrometer. The band gap of Ga₂O₃ was engineered by alloying with indium during growth from zero to 100%. Then, the effect of engineering the band gap on the shallow and deep levels was investigated by measuring the TSE glow curves using the TSE spectrometer (FIG. 8). Alloying GaO by In narrowed the band gap (see FIG. 10) and led to new energy levels. Such levels dictate the electrical and optoelectronic properties of semiconductor films. Indeed, these measurements illustrate the vital applications of the developed TSE spectrometer in functional materials.

### Effect of Ion Implantation and Radiation Damage on Electronic Properties

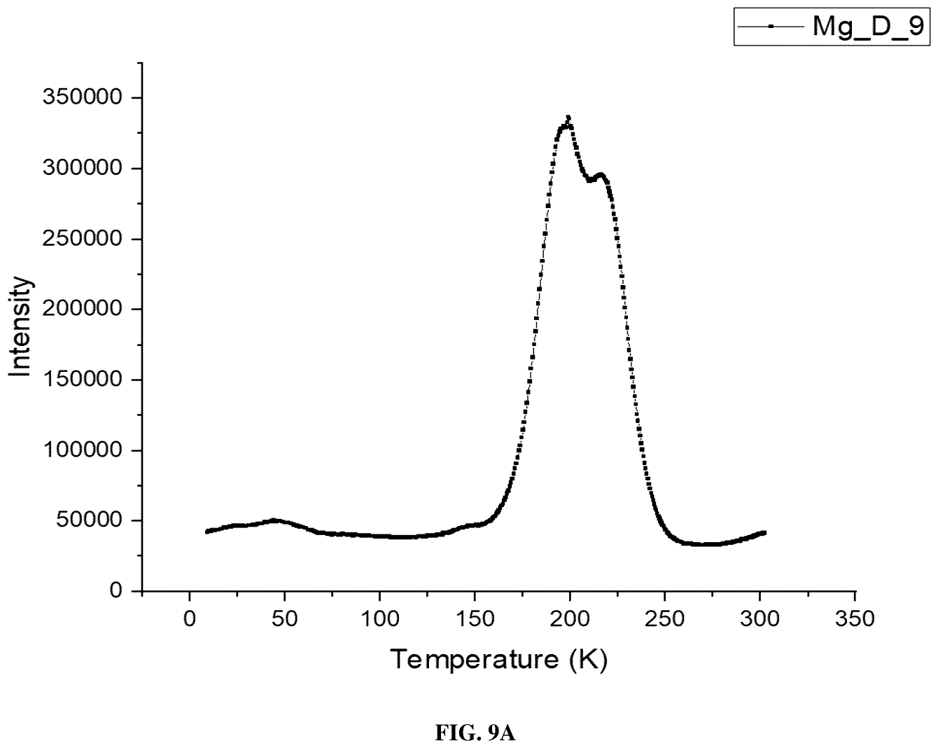

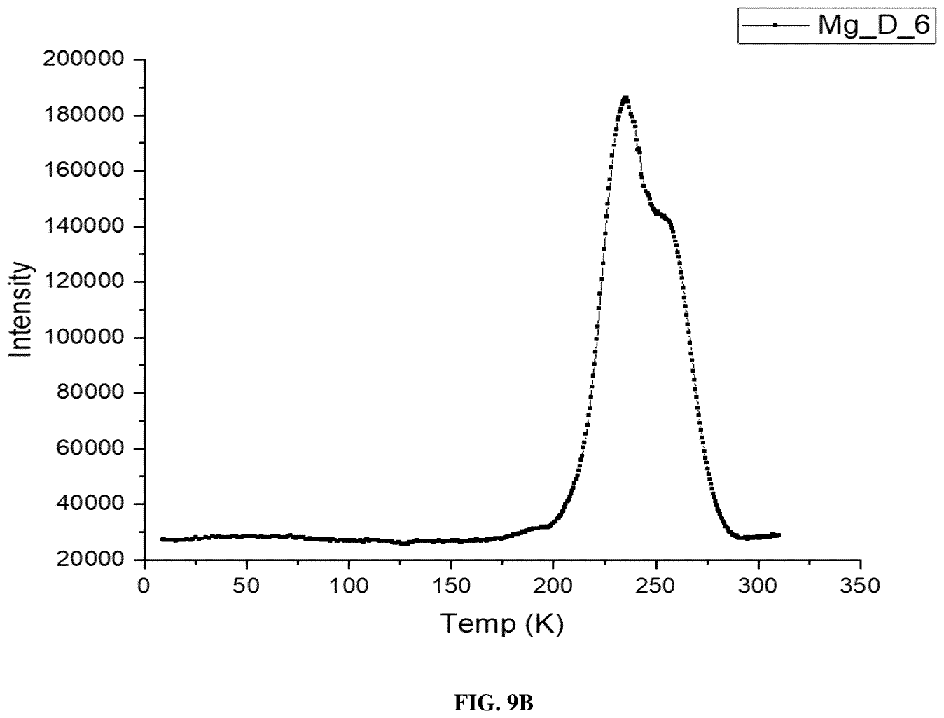

GaInO films grown by MOCVD with different In percentage and exhibiting variable band gap energies were irradiatied and implanted with Mg ions. FIGS. 9A-9B show two examples of GaInO irradiated with 50 keV Mg ions. The graphs show the emergence of a large peak in each film at relatively high temperature after irradiation, indicating the presence of high concentrations of deep traps due to radiation induced defects. The position and intensity of the peak are dependent on the Mg percentage in the film, as it can be seen in the figure that the peak position in the film with 20% In is shifted to higher temperature, likely because of its widest band gap as shown in FIG. 10. The peak is also less intense, indicating that the alloy with higher band gap is more resistant to radiation. Thus, by using the TSE spectrometer, new fundamentals in materials science can be revealed. The TSE spectrometer also provides a useful tool to study defects induced by ion implantation and radiation damage in oxides and band gap materials.

Certain embodiments of the devices and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the devices and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1. A thermally stimulated emission (TSE) spectrometer comprising:
a cryostat housing a sample stage in an area;
a cooling source configured to lower a temperature of the area to as low as 9 K;
a photo-excitation source configured to deliver electromagnetic radiation to a sample on the sample stage;
a heat source configured to heat the area;
a temperature control unit configured to control the cooling source and the heat source, so as to cool or heat the area;
a monochromator configured to receive light emitted from the sample on the sample stage as the area is being heated by the heat source, and emit a specific wavelength of the light;
a photomultiplier tube (PMT) configured to detect the light emitted from the monochromator at the specific wavelength or the light emitted directly from the sample covering all wavelengths;
a photon counter in communication with the photomultiplier tube, the photon counter being configured to count photons detected in the light by the photomultipler tube; and
a data acquisition unit in communication with the photon counter and the temperature control unit, the data acquisition unit being configured to obtain and display information about the photons emitted from the sample as a function of one or more of time, wavelength, and temperature.

2. The TSE spectrometer of claim 1, wherein the cooling source comprises a compressor and heat exchanger with a source of liquid helium.

3. The TSE spectrometer of claim 2, wherein the compressor and the heat exchanger are configured to deliver the liquid helium to the cryostat.

4. The TSE spectrometer of claim 1, wherein the temperature control unit is configured to control the temperature of the cryostat.

5. The TSE spectrometer of claim 4, wherein the sample stage is configured to support the sample and a temperature sensor, wherein the sample stage is in communication with the temperature control unit.

6. The TSE spectrometer of claim 1, further comprising a temperature sensor on the sample stage.

7. The TSE spectrometer of claim 1, further comprising a vacuum pump configured to maintain a desired pressure in the area.

8. The TSE spectrometer of claim 1, wherein the photoexcitation source is configured to excite charge carriers in a sample on the sample stage.

9. A method for conducting spectrometry, the method comprising:
housing a sample in a cryostat;
lowering a temperature in the cryostat to about 9 K;
exciting the sample with a photo-excitation source to cause charge carriers in the sample to move into defect states or traps;
heating the sample over a period of time; and
analyzing photons given off from the sample over the period of time in order to determine characteristics of the defect states or traps.

10. The method of claim 9, wherein a pressure inside the cryostat is reduced to about 10 mtorr or less before the temperature is lowered.

11. The method of claim 9, wherein the temperature is lowered by pushing helium inside the cryostat and expanding the helium inside the cryostat in two stages.

12. The method of claim 9, wherein the analyzed photons are of one wavelength.

13. The method of claim 9, wherein the analyzed photons are of multiple wavelengths.

14. The method of claim 9, comprising deconvoluting highly overlapped thermally stimulated emission signals with a three-point analysis (TPA) method.

15. The method of claim 9, comprising detecting the photons given off from the sample with a photomultiplier tube.

16. The method of claim 9, comprising restricting the photons analyzed to photons having a certain wavelength with a monochromator.

17. The method of claim 15, comprising counting the photons detected by the photomultiplier tube with a photon counter.

18. The method of claim 9, wherein the sample is excited with UV light.

19. The method of claim 9, wherein the sample is excited with bandgap light to cause charge carriers to get trapped.

20. The method of claim 9, wherein the sample is excited with sub-bandgap light to allow charge carriers to move from a defect state into a conduction band of the sample.

21. The method of claim 9, wherein the sample is a semiconductor material.

22. The method of claim 9, wherein the sample is a photonic material.

23. The method of claim 9, wherein the sample is an insulating material.

24. A method for detecting low levels of shallow traps, donors, acceptors, or defects in any form of materials, bulk material, film, or nanomaterials, the method comprising conducting thermally stimulated emission spectrometry on the materials, bulk material, film, or nanomaterials.
